(19) United States
(12) Patent Application Publication
(10) Pub. No.: US 2009/0034852 A1
(43) Pub. Date: Feb. 5, 2009

(54) Method and System for Identifying the Source of an Image

(76) Inventor: Chris Brock, Manorville, NY (US)

Correspondence Address: MOTOROLA, INC., 1303 EAST ALGONQUIN ROAD, IL01/3RD, SCHAUMBURG, IL, 60196, US

(21) Appl. No.: 11/830,989

(22) Filed: Jul. 31, 2007

(51) Int. Cl. G06K 9/36

(52) U.S. Cl. 382/232

(57) ABSTRACT

Described are a method and a system for identifying the source of an image. A first image is generated with an imaging device. The first image is represented by a first plurality of codes. A portion of the first plurality of codes is replaced with a further code providing information about the imaging device to generate a second image including a second plurality of codes.

### FIELD OF INVENTION

The present invention generally relates to a system and method for identifying the source an image provided by an imaging device.

### BACKGROUND

Imaging devices (e.g., image-based barcode scanners, optical character readers, digital cameras, etc.) are used in a multitude of situations for both personal and business purposes. These imaging devices may be incorporated into a variety of different configurations, such as a fixed scanning station, or alternatively, a handheld portable scanning device. The portability of the imaging devices allows for several advantages, such as tracking products from a manufacturer to a retailer. Furthermore, large amounts of digital image data may be collected by the imaging devices at high rates and then transmitted to a compatible data processing device for processing the digital image data.

Digital image processing is the use of computer algorithms to perform image processing on digital images received from imaging devices. Digital image processing has the same advantages over analog image processing as digital signal processing has over analog signal processing. Specifically, digital image processing may allow for a much wider range of algorithms to be applied to the input data, and can avoid problems such as the build-up of noise and signal distortion during processing. The software utilized for the digital image processing may be described as image-decoding software. A developer of image-decoding software may wish to control the usage of the software through limiting the operability of the software to a specific group of imaging devices. In addition, it would advantageous to allow the data processing devices to determine the source of the image data.

### SUMMARY OF THE INVENTION

The present invention relates to a method and a system for identifying the source of an image. A first image is generated with an imaging device. The first image is represented by a first plurality of codes. A portion of the first plurality of codes is replaced with a further code providing information about the imaging device to generate a second image including a second plurality of codes.]

### BRIEF DESCRIPTION OF THE DRAWINGS

FIG. 1 shows an exemplary system for embedding an identification code into an image generated by an imaging device according to the exemplary embodiments of the present invention.

FIG. 2 shows an exemplary method for embedding an identification code into an image generated by an imaging device according to the exemplary embodiments of the present invention.

FIG. 3 represents an exemplary method for authenticating a source of image data received from an imaging device from the perspective of an image-decoding system according to the exemplary embodiments of the present invention.

FIG. 4 illustrates the alteration of a first digital image to an altered second digital image according to an exemplary embodiment of the present invention.

### DETAILED DESCRIPTION

The present invention may be further understood with reference to the following description of exemplary embodiments and the related appended drawings, wherein like elements are provided with the same reference numerals. The present invention is related to a system and method for verifying the source of an image generated by an imaging device. Specifically, the present invention is related to a system and method for encoding an identification code (e.g., a serial number) into generated image data, wherein the identification code identifies an imaging device as the source of the image data. Accordingly, the exemplary embodiments of the present invention allow for a data processing device to determine a source of image data. Thus, the data processing devices may be able to ensure that the image data received is image data generated from a valid imaging device. The exemplary system and method described herein may serve to provide traceability of imaging devices that have generated images. Furthermore, the exemplary embodiments also prevent unauthorized usage of the imaging processing software.

Various embodiments of the present invention will be described with reference to an imaging device, such as, for example, a portable optical barcode scanner. However, those skilled in the art will understand that the present invention may be implemented with any electrical and/or mechanical imaging device that is capable generating a digital image of any automatic identification symbol, such as a barcode. As will be described in further detail below, the image data generated by the exemplary imaging device may include information pertaining to the manufacturer and/or the imaging device, itself. Furthermore, the exemplary imaging device may include one or more application-specific integrated circuit (“ASIC”) chips designed for performing customized (or “semi-customized”) applications. ASIC chips designed for semi-customized application may be made from field programmable gate arrays, wherein only the top layer, or layers, of metal interconnects defines the circuit function. In ASIC chip performing fully customized application, all layers are defined to achieve the circuit function. While the exemplary embodiments of the present invention describe the use of an ASIC, it should be noted that the any other mechanism capable of providing customizable application and of similar technology may be implemented within the image device.

According to alternative or additional embodiments of the present invention, the image device may utilize a micro component, such as a digital assistant micro. The digital assistant micro may be capable of managing various applications of the image device. For example, the digital assistant micro may manage an illumination component of the image device, synchronize the activation of the illumination component with a image capturing component, monitor the temperature of the image device, etc.

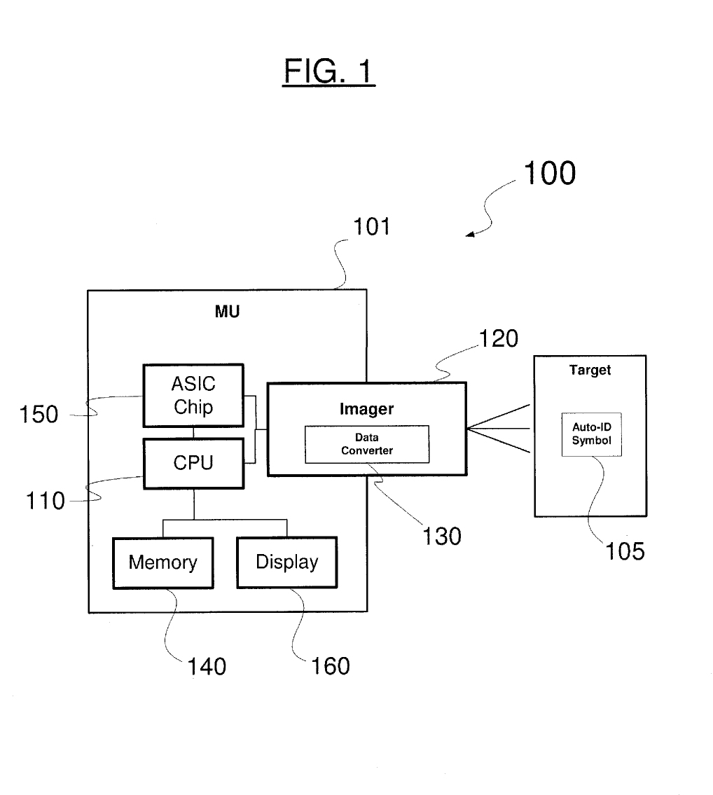

FIG. 1 shows an exemplary system 100 for embedding an arbitrary code (e.g., an identification code, a device serial number, a manufacturer code, a facility code, and a product line code, etc.) into an image generated by an imaging device according to the exemplary embodiments of the present invention. Specifically, exemplary system 100 may include an imaging device such as hand-held scanning mobile unit (“MU”) 101 for generating image data of a target, such as a computer-readable automatic identification (“auto-id”) symbol 105. According to the exemplary embodiments of the present invention, the MU 101 may capture and store images electronically in a digital format. For example, the exemplary MUs 101 may include a photo-detector, such as charge couple device (“CCD”). This class of barcode scanners or imagers is generally known as CCD scanners. CCD scanners can record symbols by storing an image of the symbol in a frame memory, which is then processed (e.g., scanned electronically) using software in order to convert the captured image into an output signal. While the imaging devices discussed for the exemplary embodiments for the present invention are described as CCD scanner, it should be noted that the present invention may be implemented by any data acquisition device having imaging capabilities, such as photo detectors, image sensors, active pixel sensors using complementary metal-oxide-semiconductor (“CMOS”) technology, etc.

The MU 101 may include a “function module” or a central processing unit (“CPU”) 110, an imaging component (e.g., imager 120), a data converter 130, a memory 140, at least one ASIC chip 150, and a display screen 160. The CPU 110 may include one or more electrical and/or mechanical components for executing a function of the exemplary MU 101. For example, the CPU 110 may include an analog-to-digital converting arrangement for processing image data received from the imager 120. The CPU 110 may also include software components for controlling operation of the electrical/hardware components of the MU 101.

The CPU 110 may regulate the operation of the MU 101 and its components by facilitating communications between the various components of the MU 101. For example, the CPU 110 may include various computing arrangements, such as, a processor (e.g., a microprocessor), an embedded controller, a programmable logic array, etc. The CPU 110 may perform data processing, execute instructions and direct a flow of data between devices coupled to the CPU 110 (e.g., the imager 120, the memory 140, the data converter 130, the ASIC chip 150, etc.). As will be explained below in further detail, the CPU 110 may receive an input of image data from the imager 120 and in response, may instruct the data converter 130 of the MU 101 to converter the image data and insert additional data (e.g., MU 101 or imager 120 serial number) into the image data, thereby altering a portion of the image data. Accordingly, the CPU 110 may then store the altered image data in the memory 140 of the MU 101.

The memory 140 may be any storage medium capable of being read from and/or written to by the CPU 110, or another processing device within the MU 101. The memory 140 may include any combination of volatile and/or nonvolatile memory (e.g., RAM, ROM, EPROM, Flash, etc.). The memory 140 may also include one or more storage disks such as a hard drive. Accordingly to one embodiment of the present invention, the memory 140 may be a temporary memory in which data may be temporarily stored until it is transferred to a permanent storage location (e.g., uploaded to a personal computer). In another embodiment, the memory 140 may be a permanent memory comprising an updateable database.

The imager 120 may include any combination of hardware and/or software for capturing image data of a target, such as the auto-id symbol 105. Furthermore, the imager 120 may include the data converter 130 (e.g., an analog to digital data converter), wherein the data converter 130 may generate a digital image of the auto-id symbol 105. Specifically, the data converter 130 may be capable of converting analog image data captured from the imager 120 into a computer-readable digital representation of the image.

As described above, the ASIC chip 150 of the MU 101 may be designed for performing customized (or “semi-customized”) applications. Specifically, the ASIC chip 150 may include an arbitrary code (e.g., an identification code or a serial number of the MU 101). For example, the exemplary identification code may be established at the time of manufacture for the MU 101, and thus be saved by the CPU 110 of the MU 101 onto the ASIC chip 150. Therefore, the ASIC chip 150 may be designed to incorporate that identification code into the digital image generated by the data converter 130. According to one embodiment of the present invention, the ASIC chip 150 may alter, or embed, a predetermined number of bytes representing pixel information within a predetermined location of the image data. For example, the ASIC chip 150 may replace the first 12 to 48 bytes of pixel information of the image data with the identification code (e.g., serial number) of the MU 101. The bytes of pixel information replaced by the ASIC chip 150 is small enough so as to not impact the detectability of the auto-id symbol 105, and may be practically unnoticeable in an image acquisition.

Embedding the identification code into the image data may allow for the source of the image to be located. Specifically, the identification code allows for tracing the manufacturing information on an image generated by a customer using the MU 101. For example, customer support during a problem resolution session may be drastically improved by easily identifying the one or more source MUs 101 that generated images. The traceability of each of the source MUs 101 may also allow for simplified manufacturing record keeping. Further, the use of the identification code may prevent decoding software from being used by unapproved devices and/or enterprises. Specifically, the identification code may be a key to an encrypted string that may be required in order to decode the digital image containing the identification code. The encryption scheme of the string may be a short encrypted-in-the-factory string applied by the original equipment manufacturer (“OEM”). Accordingly, the decoding software of the OEM may be able to decrypted the string, extract and verify the identification code, and then decode the image data having a valid identification code. Thus, the encryption of the identification code may prevent the decoding software of the OEM from functioning in conjunction with any unauthorized image capturing devices, such as non-OEM imagers.

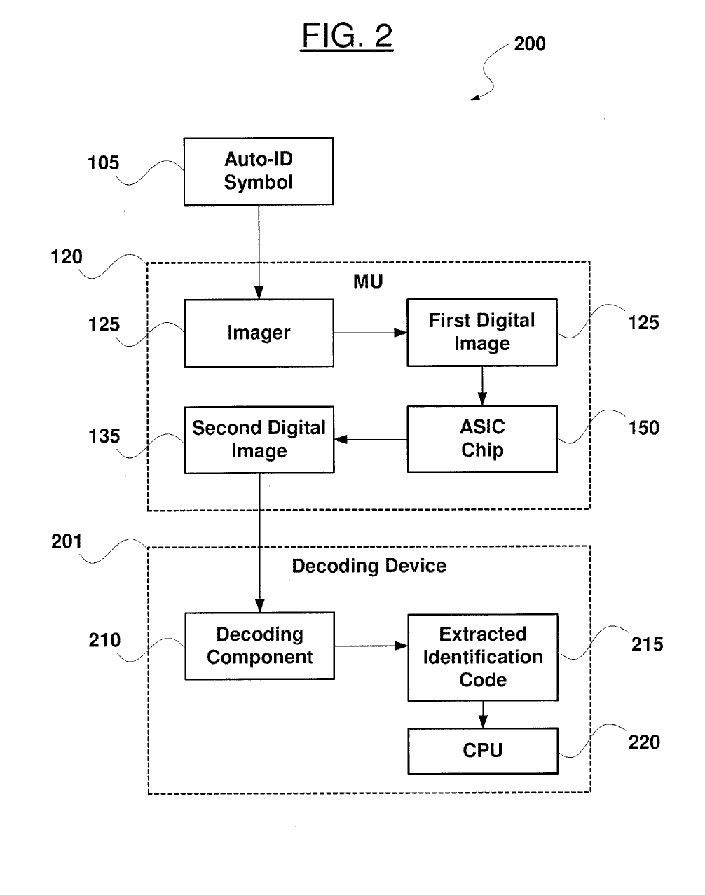

FIG. 2 represents a flow chart 200 describing the various functions of the exemplary components for embedding an identification code into a first digital image 125 generated by an imaging device MU 101, according to the exemplary embodiments of the present invention. It should be noted that while certain components, such as the imager 120 and the data converter 130, may reside on the MU 101, further components, such as the third party decoder 210 and the third party CPU 220, may reside on a separate decoding device 201. However, alternative embodiments of the present invention may allow for each of the described functions to be performed by components within a single device, such as MU 101.

According to the exemplary embodiments of the present invention, a user of the MU 101 may wish to capture an image of a target, such as auto-id symbol 105, for data processing. The imager 120 of the MU 101 may be used to create a digital representation of the auto-id symbol 105. As described above, the data converter 130 of the MU 101 may convert the analog image data of the auto-id symbol 105 into computer-readable digital image data, in the form of the first digital image 125. The first digital image 125 may be then forwarded to the ASIC chip 150 for additional data conversion. Specifically, the ASIC chip 150 may convert a small portion of the digital image data (e.g., the first 12 to 48 bytes of pixel information) into an embedded identification code, such as the MU 101 serial number. Thus, the ASIC chip 150 may output an altered, second digital image 135 including the corresponding identification code (e.g., the first digital image 125 plus the device serial number).

The separate decoding device 201 may receive the second digital image 135 from the MU 101. This device 201 may include a decoding component 210 capable of extracting the embedded identification code from the second digital image 135. As described above, an embodiment of the present invention may encrypt the digital image data including the identification code. Accordingly, the decoding component 210 may also decrypt the second digital image 135 in order to output an extracted identification code 215. This extracted identification code 215 may be received by a processing component, e.g., the CPU 220, of the decoding device 201 in order for the CPU 220 to determine the source of the image data. The CPU 220 may compare the extracted identification code 215 to a database of identifications identifying a plurality of imaging devices. The CPU 220 may validate the received image data if the identification code identifies an authorized imaging device as the source of the image data. Alternatively, the CPU 220 may invalidate the second digital image 135 if the imaging device identified by the identification code is not contained within the database, or if the received image data does not include any identification code.

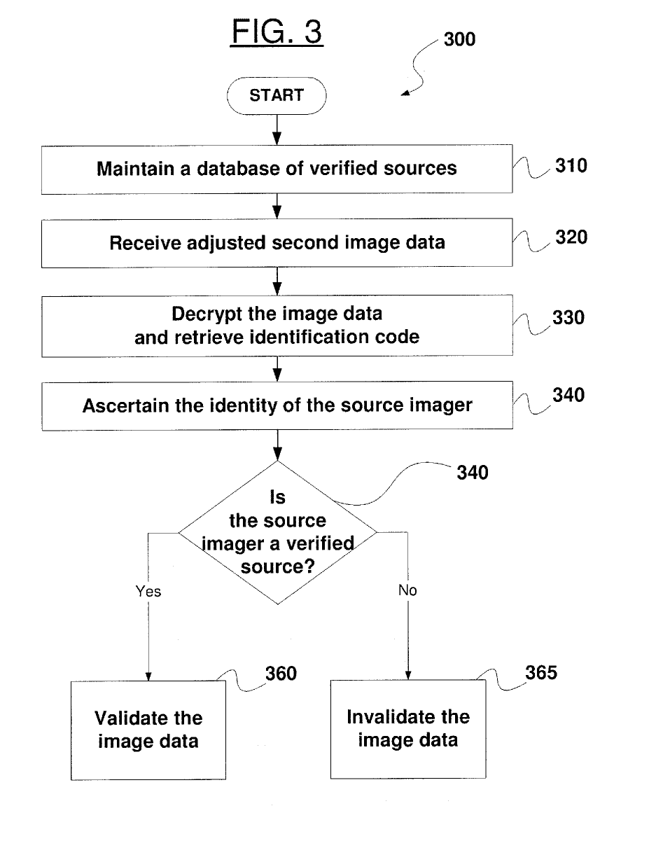

FIG. 3 represents an exemplary method 300 for authenticating a source of image data received from an imaging device, such as MU 101, from the perspective of an image-decoding system, such as the separate decoding device 201 of FIG. 2, according to the exemplary embodiments of the present invention. According to the exemplary embodiments of the present invention, the image-decoding system may operate within an OEM image processing system, or alternatively, on a third party system. The exemplary method 300 will be described with references to the exemplary system 100 of FIG. 1 and the flow chart 200 of FIG. 2. As described above, the exemplary MU 101 may be a device such as an optical barcode scanner. In order to authenticate the source of image data received from MU 101, the MU 101 may be assigned a unique identification code, such as a device serial number. In order to prevent unauthorized devices from operating the decode software of the OEM, the unique identification code may ensure that the source of the image is from an OEM device, or a device authorized by the OEM.

In step 310, the image-decoding system may maintain a database of a list of verified sources of image data. The database may contain the identification codes of all OEM imaging devices and may also include the identification codes of additional devices authorized to submit image data to the image-decoding system. Accordingly, the database may be continuously adjusted to allow new imaging devices to be added and unused devices to be removed as verified sources. For example, if the software program that operates the image-decoding system is licensed out to a new manufacturer, the identification codes of any additional imaging devices may be incorporated into the database of the image-decoding system. Thus, images received from the additional imaging devices may be considered as originating from authorized sources.

In step 320, the image-decoding system may receive image data (e.g., the adjusted second image data 135 of FIG. 2), from an imaging device, such as MU 101. As described above, the image data may be an image of an auto-id symbol 105, such as a barcode from a product, a parcel, a document, an event/transportation ticket, etc. The image data may be received as a digital representation of the auto-id symbol 105. It should be noted, that while the exemplary embodiment discussed in method 300 are described in relation to digital image data of an auto-id symbol 105, the present invention may be applied to the capturing and processing of any type of digital images, regardless of the presence of a symbol within the image.

In step 330, the image-decoding system may decrypt the image data received from the imaging device in order to retrieve the identification code. According to an embodiment of the present invention, the identification code may be encrypted into the image data to prevent any outside persons or devices from reading, or otherwise accessing, the identification code. Thus, the image-decoding system may possess the proper decrypting key necessary to read to the embedded identification code within the image data.

In step 340, the image-decoding system may ascertain the identity of the imaging device based on the identification code decrypted from the image data. The identity of the imaging device may be used for both verifying authorized devices and for tracking (or tracing) manufacturing information on a digital image. As described above, the identification code allows for improved problem resolution. Specifically, any image included within a customer service issue report may be associated with a specific imaging device as the source of that image. Thus, the identity of the source imager may be included within a resolution and/or manufacturing record for further analysis. Accordingly, service issues attributed to a single imager (or a specific group of imagers) may easily be recognized.

In step 350, the image-decoding system may compare the identification code of the source of the image data with the list of verified sources contained in the database. If the image-decoding system has determined that the source of the image data is on the list of verified sources from the database, the image decoding system may validate the image data in step 360. However, if the image-decoding system has determined that the source of the image data is not on the list of verified sources from the database, the image-decoding system may invalidate the image data in step 365. Accordingly, the software used to operate the image-decoding system may simply not process (e.g., decode) any of the invalidated image data. By only processing the validated image data, the usage of the image-decoding system and/or the software that operates the system may be easily controlled. The use of the embedded identification codes may prevent unauthorized (e.g., unlicensed, pirated, etc.) operation of the software or system with non-verified sources of image data.

According to an alternative embodiment of the present invention, the identification code embedded into the image data may contain a decryption key that is necessary to operate the software of the image-decoding system. In other words, the identification code may not only identify the source imager, it may also function to determining operability of the image-decoding system. For example, the decryption key may resolve a short in-factory encryption string available to user of the OEM devices, and other authorized users. Therefore, the use of the database listing the verified sources of image data may be eliminated. Thus, each of the valid imaging devices may be provided with the proper decryption key and a component (e.g., the ASIC chip 150) for embedding the decryption key into the image data as a part of the identification code. The identification code may still be used to track the imaging device and identify it as the source of the image data. However, the image-decoding software may rely on the proper decryption key for decoding the image data.

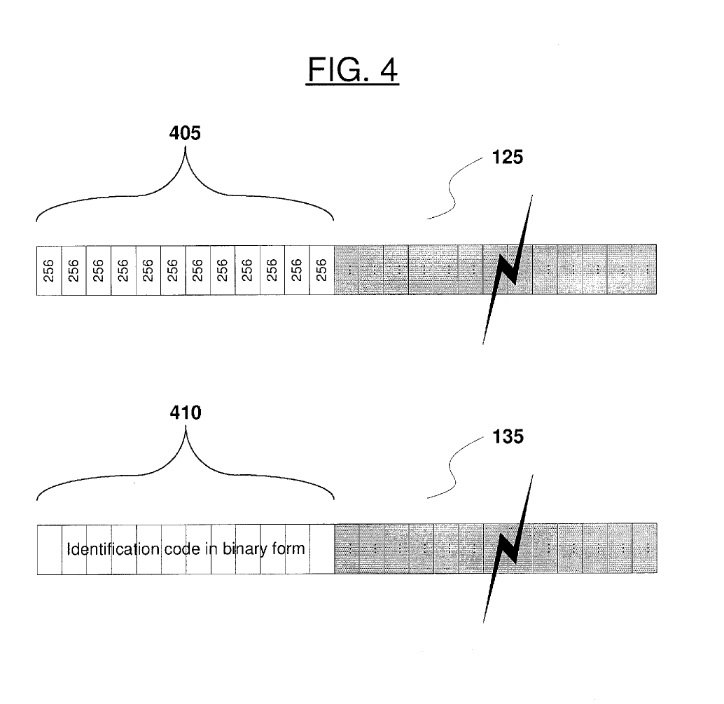

FIG. 4 illustrates the alteration of first digital image 125, from FIG. 2, to the altered second digital image 135, of FIG. 2. Accordingly, both digital images 125, 135 are represented by a stream of bytes (e.g., within a data block) having various values for each pixel of the digital images 125, 135. For example, each of the bytes in a stream may represent a single pixel within a specific location of the digital image. Furthermore, each of the bytes may have a numeric value (e.g., from 0-256) representing a gray level value for the corresponding pixel of the byte. The greater the gray level value for a pixel may correspond to a greater gray intensity (i.e., shade of gray), such that a value of 0 may represent a black pixel (i.e., low gray intensity) and a value of 256 may represent a white pixel (i.e., high gray intensity). While the above-discussed embodiment of the present invention is described in reference to a gray scale digital imaging scheme, the present invention may be applied to any type of imaging scheme that utilized a digital representation of the image data.

According to the exemplary embodiment of the present invention, a predetermined number of bytes within an image data file may be replaced with a digital representation of the identification code of the source imaging device. The digital representation of the first image 125 may include a plurality of data blocks representing each pixel of the image. For example, a portion of data 405 may be the first twelve data blocks that represent of the first twelve pixels in the digital image file (e.g., in the upper-left portion of the image). Alternatively, the portion of data 405 may be the first twelve data blocks of a header for the digital image file. Regardless of whether the portion of data 405 represents image data or header data, the portion 405 may be considered a relatively insignificant portion of the image file. If the portion 405 is in the upper-left corner of the image, any alterations made to this portion 405 may only appear as “fixed pattern noise” or interference. However, due to the relatively small portion, this noise may be difficult to detect and may not interfere with an auto-id symbol decoder's ability to accuracy read the auto-id symbol 105 within the digital image.

As illustrated in FIG. 4, the portion of data 405 may simply be twelve white pixels within the digital image 125. The remainder of the representation of image 125 may be pixels having various gray values to accurately represent an image of the auto-id symbol 105. As described above, the data contained within the digital image 125 may be altered by the ASIC chip 150 in order to embed a unique identification code 410 into the data, for example, in binary format. For example, the resulting altered second image data 135 may contain the identification code 410 within the portion of data 405 represented by the first twelve data blocks. Accordingly, the identification code 410 may be coded into numeric values, similar to the values of the gray scale for the image. While these values for the identification code 410 may alter the original appearance of the portion of data 405 they are contained in, the values may also be decoded by an image-decoding system in order to extract the identification code 410 from the second image 135. Furthermore, the remainder of the data block within the second image 135 remains unaltered, having the same gray scale values as the first image 125. According to an additional and/or alternative embodiment of the present invention, the identification code 410 of the second image 135 may be encrypted to avoid unauthorized detection or translation of the identification code 410.

While the illustration depicted in FIG. 4 includes a twelve data block portion 405, it should be noted that any number of data blocks within the first image data 125 may be used. Furthermore, the blocks that are used do not necessarily need to be consecutive blocks. Alternatively, the blocks may be scattered throughout the image data 125, spread out in predetermined locations. For example, the least significant bit from one or more pixels may be altered (e.g., adjusting the gray scale for a predetermined number of pixel by one gray level value). According to this example, an arbitrary code such as the identification code may be spread throughout the existing imaging code. If the image is a monochrome image, each pixel of the image may include a value representing the intensity of the illumination (e.g., a gray level value). The arbitrary code (e.g., identification code) may be represented within the monochrome image thought adjustments made to the gray level values of the least significant bits of the image data. Thus, the code may be discreetly added to the image data without replacing or visibly corrupting the image of the image data.

According to a further alternative embodiment of the present invention, the second image 135 may be embedded with further information, in addition to the identification code 410. For example, the second image 135 may be embedded with debugging information. This debugging information may be used to debug the decoding software. Furthermore, the second image 135 may also include time/date of image generating and camera settings of the imaging device that generated the first image 125. This information may be helpful while resolving any customer/product related issues.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
generating a first image with an imaging device, the first image being represented by a first plurality of codes; and
replacing a portion of the first plurality of codes with a further code providing information about the imaging device to generate a second image including a second plurality of codes.

2. The method according to claim 1, wherein the further code is one of an identification code, a device serial number, a manufacturer code, a facility code, and a product line code.

3. The method according to claim 1, wherein the first image includes a representation of an automatic identification symbol.

4. The method according to claim 1, wherein the further code includes an encryption key readable by an image decoding device.

5. The method according to claim 1, further comprising:
receiving the second image;
ascertaining, from the further code, an identity of the imaging device;
determining whether the imaging device identified by the further code is a authorized source for second image;
invalidating the second image if the imaging device is not determined to be an authorized source;
validating the second image if the imaging device is determined to be an authorized source; and
decoding the second image.

6. The method according to claim 1, further comprising:
encrypting the further code within the second plurality of codes of the second image.

7. The method according to claim 6, wherein the further code is encrypted with a decryption key readable by an image decoding component, the image decoding component requires the decryption key in order to decode the second image.

8. The method according to claim 1, wherein the second image is created by an integrated circuit chip.

9. The method according to claim 1, wherein the further code includes information pertaining to one or more settings of the imaging device.

10. A method, comprising:
receiving an image including a code providing information about a source of the image;
determining the source of the image based on the code; and
validating the image if the source corresponds at least one verified source.

11. The method according to claim 10, further comprising:
maintaining a database of at least one verified origin; and
comparing the source of the image to the at least one verified source of the database in order to validate the image.

12. The method according to claim 10, wherein the code is one of an identification code, a device serial number, a manufacturer code, a facility code, and a product line code.

13. The method according to claim 10, wherein the image includes a representation of an automatic identification symbol.

14. The method according to claim 10, further comprising:
encrypting the code within the second image.

15. The method according to claim 14, wherein the code is encrypted with a decryption key readable by an image decoding component, the image decoding component requires the decryption key in order to decode the image.

16. The method according to claim 10, wherein the code includes information pertaining to one or more settings of the source of the image.

17. A device, comprising:
an imager capturing an image of a target; and
a circuit altering the image to include a code providing information about the device.

18. The device according to claim 17, wherein the code is one of an identification code, a device serial number, a manufacturer code, a facility code, and a product line code.

19. The device according to claim 17, wherein the imager includes a data converter generating a digital representation of the target.

20. The device according to claim 17, wherein the target is a barcode.

21. The device according to claim 17, wherein the integrated circuit chip alters a predetermined portion of the image.

22. The device according to claim 21, wherein the predetermined portion of the image is within a range of 12 to 48 bytes of pixel information within the image.

23. The device according to claim 21, wherein the predetermined portion of the image is a least significant bit from a corresponding number of pixels within the image.

24. A system, comprising:
imaging means for capturing an image of a target; and
processing means for altering the image to include a code providing system-related data.
